(19) United States
(12) Patent Application Publication
(10) Pub. No.: US 2005/0023239 A1
(43) Pub. Date: Feb. 3, 2005

(54) Indication device for remaining volume of feeding bottle

(75) Inventor: Tai-Sheng Lin, Taipei (TW)

Correspondence Address: BUCKNAM AND ARCHER, 1077 Northern Blvd., Roslyn, NY, 11576, US

(73) Assignee: LES ENPHANTS CO., LTD.

(21) Appl. No.: 10/695,502

(22) Filed: Oct. 28, 2003

(30) Foreign Application Priority Data
Jul. 31, 2003 (TW) 092213945

(51) Int. Cl. G01F 22/00; A61J 9/00

(52) U.S. Cl. 215/365; 215/11.1

(57) ABSTRACT

An indication device for remaining volume of a feeding bottle comprises a bottle body, having an accommodating space therein for holding milk liquid, and a plurality of scale lines parallel to a horizontal line along the direction of a vertical line on one side face thereof, wherein numerals provided on the scale lines, served for displaying the volume, are step-up from downside to upside; a bottle cap part, one end of which has a nipple part penetrating through the center thereof, and the other end of which is screwed tightly onto a neck portion of the bottle body, the top end of the nipple part including an opening for releasing milk liquid; wherein a plurality of scale lines parallel or non-parallel to the horizontal line along the direction of the vertical line are provided on the other side face of the bottle body, and numerals provided on the scale lines, served for displaying the remaining volume, are step-up from upside to downside. Thus, it is possible for observing remaining volume of milk liquid at any time when feeding.

### BACKGROUND OF THE INVENTION

As illustrated in FIG. 1, there is shown a commonly conventional feeding bottle (1), essentially comprising a bottle body (10) having an accommodating space therein for holding milk liquid (14), a bottle cap part (11), one end of which has a nipple part (12) penetrating through the center thereof, and the other end of which is screwed tightly onto a neck portion of the bottle body (10), the top end of the nipple part (12) including an opening (12) for releasing milk liquid (14); wherein a plurality of scale lines (15) parallel to a horizontal line are provided, along the direction of a vertical line, on one side face of the bottle body (10), and numerals (16), provided on the scale lines, served for indicating the volume are step-up from downside to upside. Thus, information with respect the volume could be provided exactly when preparing milk liquid.

For the above conventional feeding bottle (1), although information with respect to volume could be acquired via the numerals (16) at side scale lines (15), provided on the bottle body (10), corresponding to the liquid surface of milk liquid (14), however, the presupposition is that the measure must be performed under the condition of upright bottle body (10) and stable liquid surface. Unless the feeding operation is interrupted and then the bottle body (10) is adapted to be upright, the remaining volume of milk liquid (14) could not be known during feeding. Thus, there still exists a room to be improved in use.

### FIELD OF THE INVENTION

The present invention is related to an indication device for remaining volume of a feeding bottle, particularly to a novel device allowed for observing remaining volume of milk liquid at any time when feeding.

### SUMMARY OF THE INVENTION

For the conventional feeding bottle, due to the fact that the volume measuring could be performed under the static condition only, there still exists a room to be improved. What is conceived by the inventor is that, in an ideal case, the dynamic display for remaining volume should be provided for the feeding bottle, such that the remaining volume of milk liquid could be observed at any time during feeding. As such, it is a primary object of the present invention to provide an indication device for remaining volume of a feeding bottle.

For the purpose of achieving aforementioned and other objects, the present invention comprises a bottle body, having an accommodating space therein for holding milk liquid, and a plurality of scale lines parallel to a horizontal line along the direction of a vertical line on one side face thereof, wherein numerals provided on the scale lines, served for displaying the volume, are step-up from downside to upside; a bottle cap part, one end of which has a nipple part penetrating through the center thereof, and the other end of which is screwed tightly onto a neck portion of the bottle body, the top end of the nipple part including an opening for releasing milk liquid; wherein a plurality of scale lines parallel or non-parallel to the horizontal line along the direction of the vertical line are provided on the other side face of the bottle body, and numerals provided on the scale lines, served for displaying the remaining volume, are step-up from upside to downside.

According to the present invention, a plurality of scale lines with different angles may be included for providing on the remaining volume-displaying scale line of one and the same scale in order to adapt itself to the dynamic inclined surface of liquid for observing the remaining volume of milk liquid at any time.

### BRIEF DESCRIPTION OF DRAWINGS

FIG. 1 is a schematic view of a conventional indication device for volume of a feeding bottle.

FIG. 2 is a front view of an indication device for remaining volume of a feeding bottle according to one embodiment of the present invention.

FIG. 2a is a rear view of the FIG. 2.

FIG. 3 is a schematic view of an operating state according to the embodiment of the present invention.

FIG. 3a is a schematic view of an operating state at a different angle according to the embodiment shown in FIG. 3.

FIG. 4 is a schematic view of an operating state according to another embodiment of the present invention.

FIG. 4a is a schematic view of an operating state at a different angle according to the embodiment shown in FIG. 4.

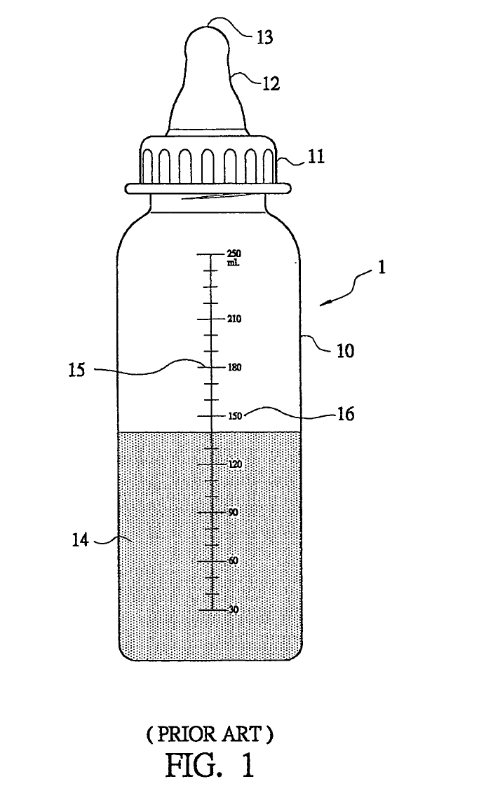

### DETAILED DESCRIPTION OF THE INVENTION

The technical features of the present invention will be further described in conjunction with embodiments. The embodiments are merely a preferred example and not to be construed as limiting the scope of the present invention. The best understanding will be obtained by reference to the following detailed description together with the accompanying drawings.

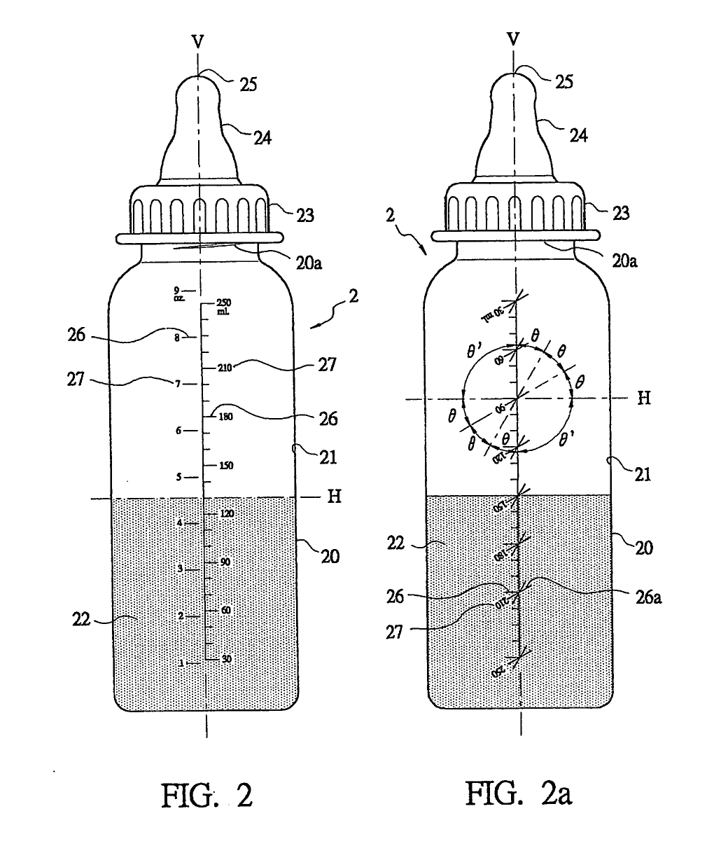

Firstly, referring to FIG. 2, the construction of an indication device 2 for remaining volume of the feeding bottle according to present invention, comprises a bottle body 20, having an accommodating space 21 therein for holding milk liquid 22; a bottle cap part 23, one end of which has a nipple part 24 penetrating through the center thereof, and the other end of which is screwed tightly onto a neck portion 20a of the bottle body 20, the top end of the nipple part 24 including an opening 25 for releasing milk liquid 22. For acquiring correct information with respect to volume, during preparing milk liquid, a plurality of scale lines 26, such as scale lines 26 for displaying the unit of volume or weight, parallel to a horizontal line H are provided, along the direction of a vertical line V, on one side face of the bottle body. Further, numerals 27, provided on the scale lines 26, served for displaying the unit of volume or weight, are step-up from downside to upside, corresponding to the volume or weight of the bottle body 20, respectively. Thus, information with respect the volume or weight of milk liquid could be provided exactly when preparing milk liquid.

Further, referring to FIG. 2a, the difference on the present invention is that a plurality of scale lines 26, 26a, either parallel or non-parallel to the horizontal line H, are provided on the other side face of the bottle body 20 along the direction of the vertical line V. Furthermore, the numerals 27, provided on the scale lines 26, 26a, served for indicating the remaining volume are step-up from upside to downside. In accordance with the present invention, the numerals 27 for the remaining volume indication may be used for the unit of volume (ml.) or weight (oz.), or both of them. In the scale lines 26, 26a for the remaining volume indication, a plurality of inclined scale lines 26, 26a with different angles may be included for providing on one and the same scale lines 26, 26a in order to adapt itself to the dynamic surface of liquid milk 22, and scale lines 26, 26a with different angles may intersect at a center point with a consistent angle θ or inconsistent angle θ′. Preferably, the scale lines 26, 26′ with different angles may maintain the angle θ or θ′ at approximately 5° to 45°.

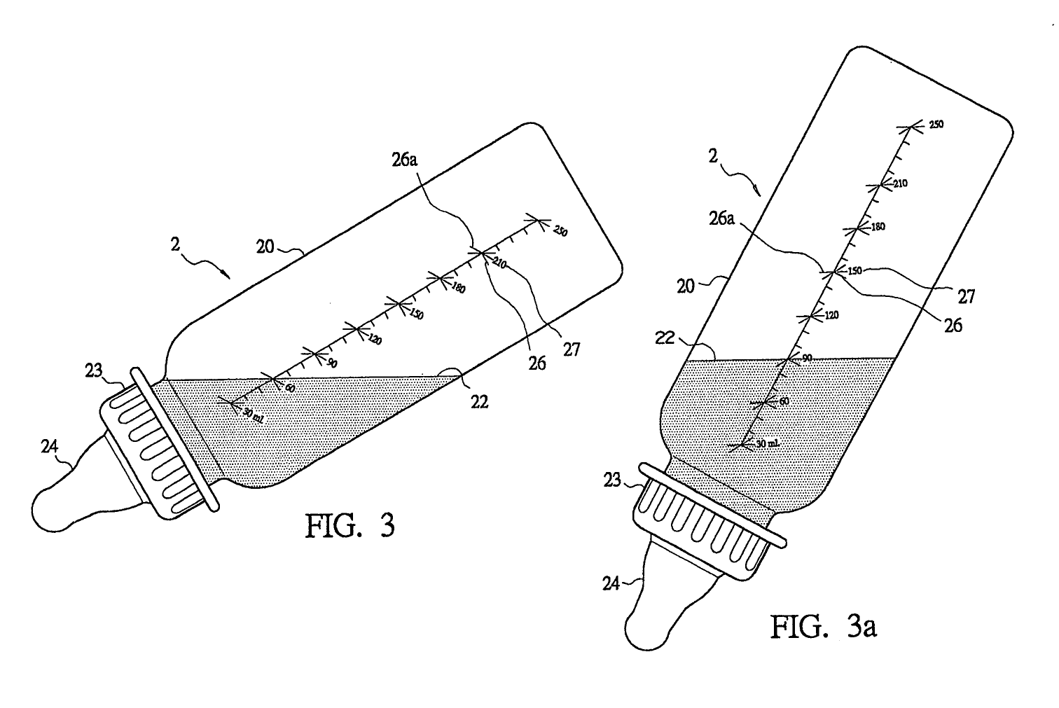

In accordance with the present invention, when the bottle body 20 is in a non-upright condition, generally, the nibble 24 to be oriented downward, milk liquid 22 may be easily released. As illustrated in FIGS. 3 and 3a, in the indication device 2 for remaining volume of the feeding bottle in accordance with the present invention, the same scale comprises the plurality of scale lines 26, 26′ with different angles, in order for adapting to the dynamic inclined liquid surface of milk liquid 22, and the remaining volume of milk liquid 22 may be thus observed at any time.

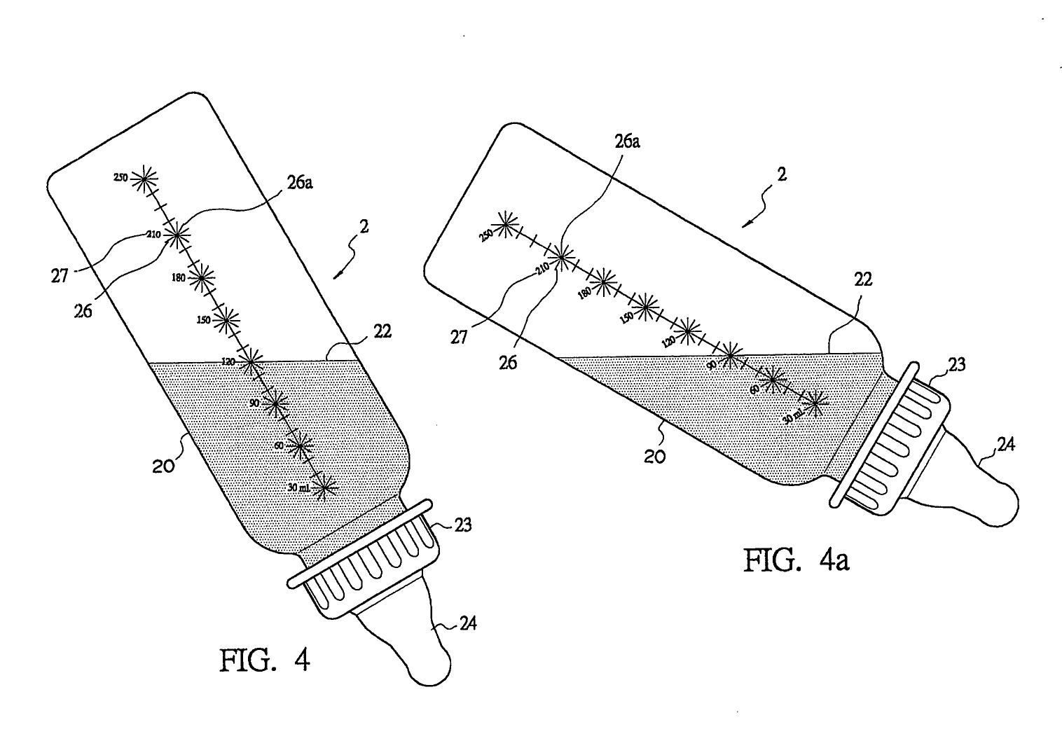

Additionally, FIGS. 4 and 4a show the indication device 2 for remaining volume of the feeding bottle according to another embodiment of the present invention. The difference on this embodiment is that the plurality of scale lines 26, 26a with different angles are included for providing on one and the same scale, and are distributed over 360° at an identical intersection point. It will be appreciated by those skilled in the art that the foregoing description may be merely preferred embodiments of present invention and not considered as restrictive. All equivalent variations and modifications in accordance with the appended claims may be made without in any way from the scope of the invention.

To sum up, the present invention is truly an invention with novelty, advancement or non-obviousness, and availability by industrial, due to the fact that the object of observing the remaining volume of milk liquid at any time may be effectively achieved by the application of the indication device for remaining volume of the feeding bottle according to the present invention without additional cost.

List of Reference Numberals

2 indication device for remaining volume of feeding bottle according to the present invention
20 bottle body
20a bottle neck
21 accommodating space
22 milk liquid
23 cap part
24 nipple part
25 opening
26-26a scale line
27 numeral
V vertical line
H horizontal line

1. (cancelled).

2. (cancelled).

3. The indication device for remaining volume of a feeding bottle according to claim 8, wherein said numerals for the remaining volume indication are used for the unit of volume or weight.

4. The indication device for remaining volume of a feeding bottle according to claim 8, wherein said plurality of scale lines with different angles intersect at a center point with a consistent angle.

5. The indication device for remaining volume of a feeding bottle according to claim 8, wherein said several scale lines with different angles intersect at a center point with an inconsistent angle.

6. The indication device for remaining volume of a feeding bottle according to claim 4, wherein the angles between said cale lines are presented between 5° and 45°.

7. The indication device for remaining volume of a feeding bottle according to claim 5, wherein the angles between said scale lines are presented between 5° and 45°.

8. An indication device for the remaining volume of a feeding bottle, comprising:
a bottle body having an accommodating space therein for holding milk liquid and a plurality of scale lines parallel to a horizontal line along the direction of a vertical line provided on a first side face thereof, wherein numerals are provided on said scale lines serving to display the volume and which are step-up from downside to upside;
a bottle cap part, one end of which has a nipple part penetrating through the center thereof and the other end of which is screwed tightly onto a neck portion of said bottle body, the top end of said nipple prat including an opening for releasing milk liquid;
a set of scale lines parallel to each other and indicating different volumes along the direction of the vertical line provided on a second side face of said bottle body, said scale lines on said second side face including numerals serving to display the remaining volume which are step-up from upside to downside; and
a plurality of scale lines with different angles provided at each scale line of said set of scale lines on the second side face of said bottle body, each angular scale line being parallel to other angular scale lines with the same angle arranged along the set of scale lines on the second side face of said bottle body.
